(19) United States
(12) Patent Application Publication
(10) Pub. No.: US 2025/0216570 A1
(43) Pub. Date: Jul. 3, 2025

(54) FAULT POLYGON EXTRACTION FROM HORIZON ATTRIBUTES

(71) Applicant: Saudi Arabian Oil Company, Dhahran (SA)

(72) Inventors: Syed Dabeer-ul-Hasan Shah, Dhahran (SA); Muhammad Khan, Dhahran (SA)

(21) Appl. No.: 18/403,371

(22) Filed: Jan. 3, 2024

(51) Int. Cl. G01V 1/30; G01V 1/34

(52) U.S. Cl. CPC G01V 1/306; G01V 1/345

(57) ABSTRACT

Disclosed are methods, systems, and computer-readable medium to perform operations including: obtaining seismic data describing a subterranean surface; generating, based on the seismic data, structural attributes for the subterranean surface; providing the structural attributes as input to a neural network for identifying faults in the subterranean surface, where an output of the neural network includes faulted areas and fault-free areas in the subterranean surface; and generating one or more fault polygons by bounding the faulted areas in the subterranean surface, where the one or more fault polygons are graphical representations of the faulted areas on a map of the subterranean surface.

### TECHNICAL FIELD

The present disclosure generally relates to systems and methods for fault polygon extraction from horizon attributes.

### BACKGROUND

In hydrocarbon exploration, faults are fractures or zones of fractures between two blocks of rock. Faults can occur due to tectonic forces, where the blocks of rock on either side of the fault move relative to each other. This movement can be horizontal, vertical, or a combination of both, and the scale of movement can range from a few millimeters to several meters. Identifying where faults occur in a subterranean formation is important because faults can both create traps for oil and gas and can serve as pathways for their movement. That is, faults in the subsurface can be conduits or barriers to hydrocarbon flow. It is important to know the presence and the extent of these faults in order to explore and produce hydrocarbons.

### SUMMARY

This disclosure describes systems and methods for fault polygon extraction from horizon attributes in a subterranean formation. In particular, the disclosed methods and systems invert structural attributes (e.g., dip and azimuth) to fault polygons that identify the locations of faults within the subterranean formation. The disclosed methods and systems generate the fault polygons more efficiently and with greater accuracy compared to existing workflows, thereby enhancing the efficiency of underlying systems (e.g., the efficiency of the underlying processing systems) and reducing the resources consumed for the processing (e.g., time and financial resources).

Aspects of the subject matter described in this specification may be embodied in methods that include: obtaining seismic data describing a subterranean surface; generating, based on the seismic data, structural attributes for the subterranean surface; providing the structural attributes as input to a neural network for identifying faults in the subterranean surface, where an output of the neural network includes faulted areas and fault-free areas in the subterranean surface; and generating one or more fault polygons by bounding the faulted areas in the subterranean surface, where the one or more fault polygons are graphical representations of the faulted areas on a map of the subterranean surface.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, obtaining seismic data describing the subterranean surface involves receiving a three-dimensional (3D) seismic volume of a subterranean formation; and picking the subterranean surface from the 3D seismic volume of the subterranean formation.

In some implementations, the method further involves applying a surface conditioning algorithm to the seismic data describing the subterranean surface.

In some implementations, the neural network is an unsupervised neural network.

In some implementations, the method further involves performing a quality check on the one or more fault polygons.

In some implementations, the method further involves displaying, on a display device, the map of the subterranean surface and the one or more fault polygons imposed on the map of the subterranean surface.

In some implementations, the structural attributes include dip and azimuth attributes.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 is a schematic view of a seismic survey being performed to map subterranean features such as facies and faults.

FIG. 2 illustrates a three-dimensional cube representing a subterranean formation.

FIG. 3 illustrates a stratigraphic trace within the three-dimensional cube of FIG. 2.

FIGS. 4A-4C illustrate normal moveout correction and stacking a set of seismic traces.

FIG. 5 illustrates an example workflow, according to some implementations.

FIG. 6A illustrates a temporal three-dimensional subsurface without fault polygons, according to some implementations.

FIG. 6B illustrates dip attributes of the three-dimensional subsurface, according to some implementations.

FIG. 6C illustrates an azimuth attribute of the three-dimensional subsurface, according to some implementations.

FIG. 6D illustrates faulted and non-faulted areas in the three-dimensional subsurface, according to some implementations.

FIG. 6E illustrates fault polygons that identify faulted and non-faulted areas in the three-dimensional subsurface, according to some implementations.

FIG. 6F illustrates the temporal three-dimensional subsurface with imposed fault polygons, according to some implementations.

FIG. 7 illustrates a flowchart of an example method, according to some implementations.

FIG. 8 illustrates hydrocarbon production operations that include both one or more field operations and one or more computational operations, which exchange information and control exploration for the production of hydrocarbons.

FIG. 9 is a block diagram of an example computer system, according to some implementations.

### DETAILED DESCRIPTION

This disclosure describes systems and methods for fault polygon extraction from horizon attributes in a subterranean formation. In particular, the disclosed methods and systems invert structural attributes (e.g., dip and azimuth) to fault polygons that identify the locations of faults within the subterranean formation. The disclosed methods and systems generate the fault polygons more efficiently and with greater accuracy compared to existing workflows, thereby enhancing the efficiency of underlying systems (e.g., the efficiency of the underlying processing systems) and reducing the resources consumed for the processing (e.g., time and financial resources).

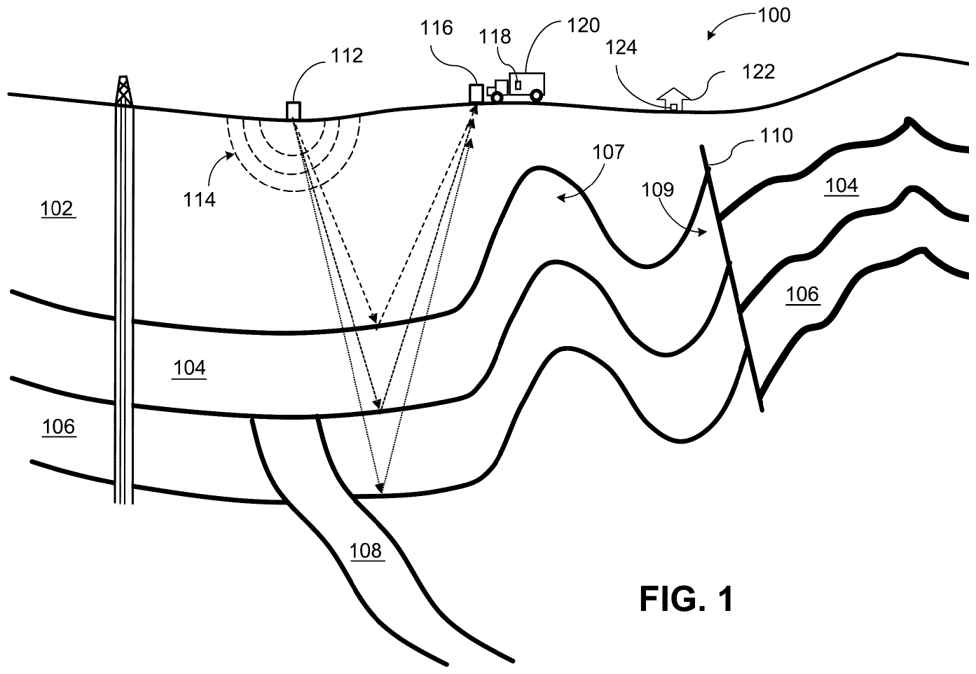

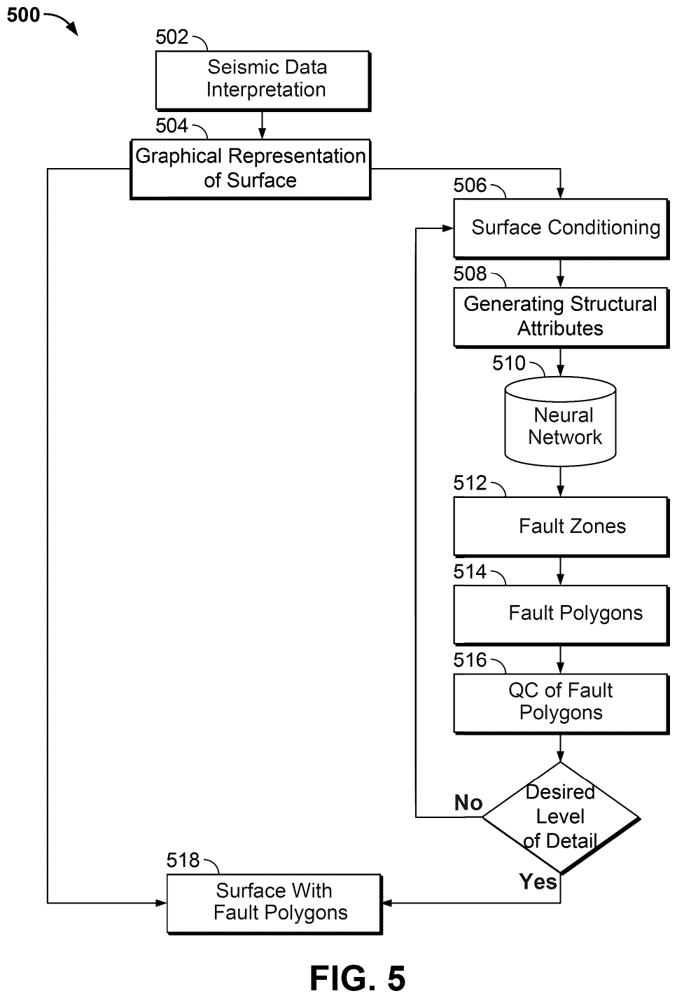

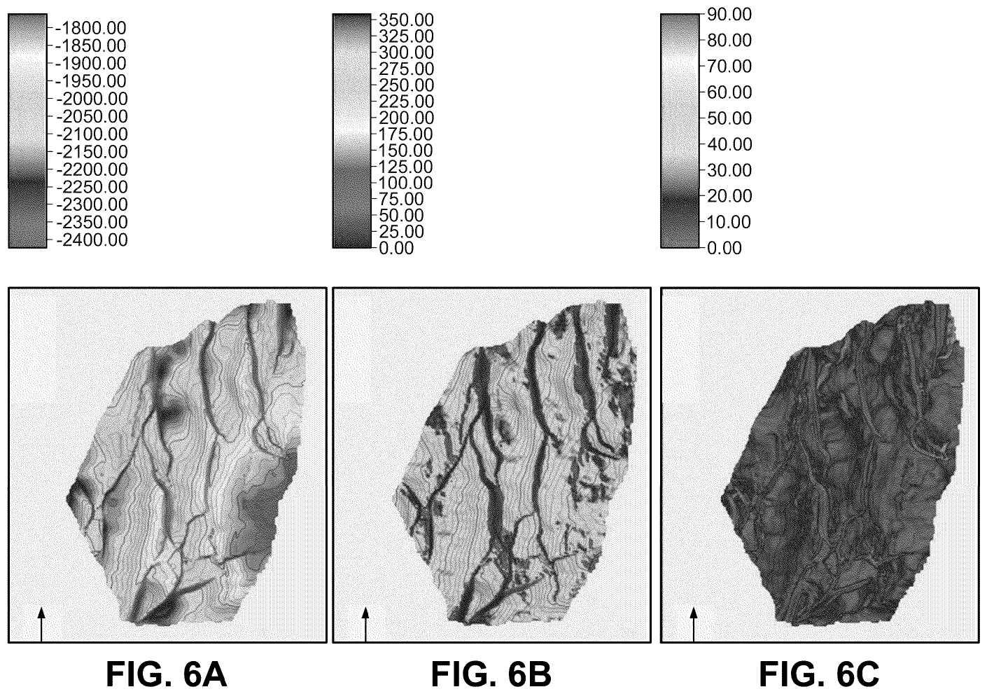

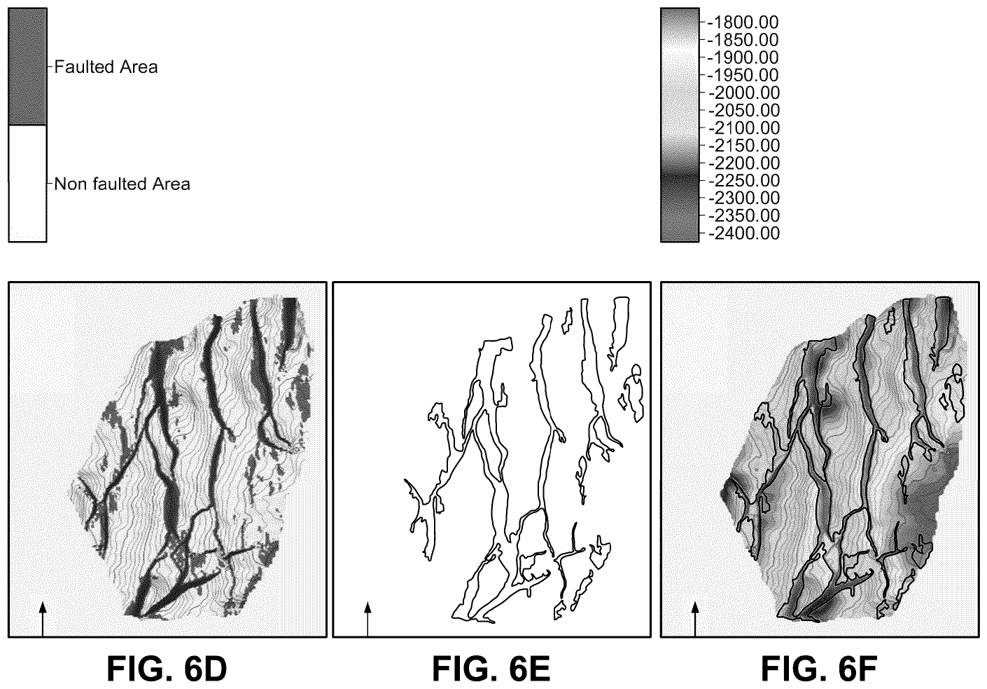

FIG. 1 is a schematic view of a seismic survey being performed to map subterranean features such as facies and faults in a subterranean formation 100. The seismic survey provides the underlying basis for implementation of the systems and methods described with reference to FIGS. 5 and 6. The subterranean formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves 114 that propagate in the earth. The velocity of these seismic waves depends properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic waves 114 contact interfaces between geologic bodies or layers that have different velocities, the interfaces reflect some of the energy of the seismic wave and refracts some of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate output signals in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer system 124 may be displayed for user viewing using local or remote monitors or other display units. One approach to analyzing seismic data is to associate the data with portions of a seismic cube representing represent the subterranean formation 100. The seismic cube can also be display results of the analysis of the seismic data associated with the seismic survey.

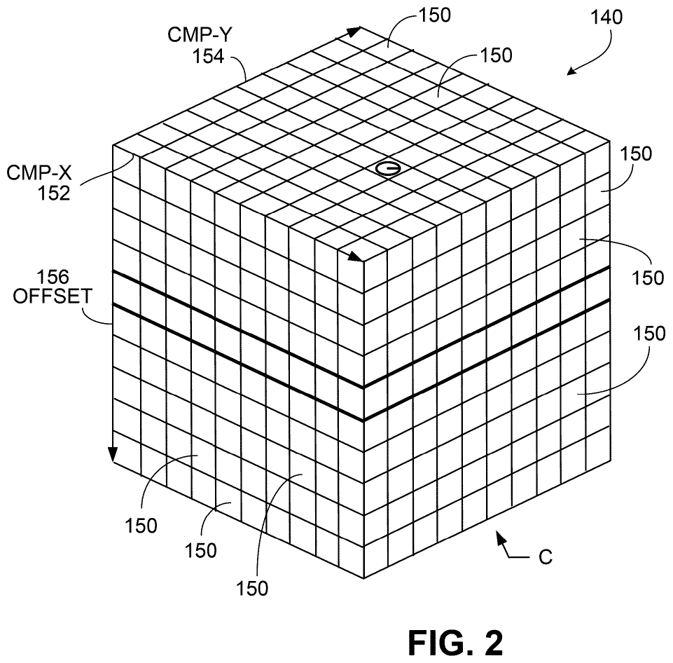

FIG. 2 illustrates a seismic cube 140 representing at least a portion of the subterranean formation 100. The seismic cube 140 is composed of a number of voxels 150. A voxel is a volume element, and each voxel corresponds, for example, with a seismic sample along a seismic trace. The cubic volume C is composed along intersection axes of offset spacing times based on a delta-X offset spacing 152, a delta-Y offset spacing 154, and a Delta-Z offset spacing 156. Within each voxel 150, statistical analysis can be performed on data assigned to that voxel to determine, for example, multimodal distributions of travel times and derive robust travel time estimates (according to mean, median, mode, standard deviation, kurtosis, and other suitable statistical accuracy analytical measures) related to azimuthal sectors allocated to the voxel 150.

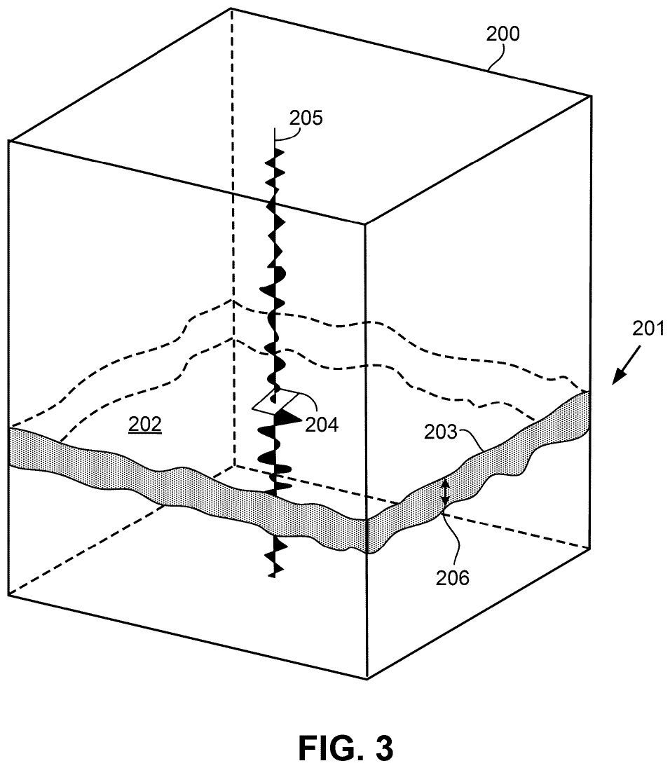

FIG. 3 illustrates a seismic cube 200 representing a formation. The seismic cube has a stratum 201 based on a surface (for example, amplitude surface 202) and a stratigraphic horizon 203. The amplitude surface 202 and the stratigraphic horizon 203 are grids that include many cells such as exemplary cell 204. Each cell is a seismic trace representing an acoustic wave. Each seismic trace has an x-coordinate and a y-coordinate, and each data point of the trace corresponds to a certain seismic travel time or depth (t or z). For the stratigraphic horizon 203, a time value is determined and then assigned to the cells from the stratum 201. For the amplitude surface 202, the amplitude value of the seismic trace at the time of the corresponding horizon is assigned to the cell. This assignment process is repeated for all of the cells on this horizon to generate the amplitude surface 202 for the stratum 201. In some instances, the amplitude values of the seismic trace 205 within window 206 by horizon 203 are combined to generate a compound amplitude value for stratum 201. In these instances, the compound amplitude value can be the arithmetic mean of the positive amplitudes within the duration of the window, multiplied by the number of seismic samples in the window.

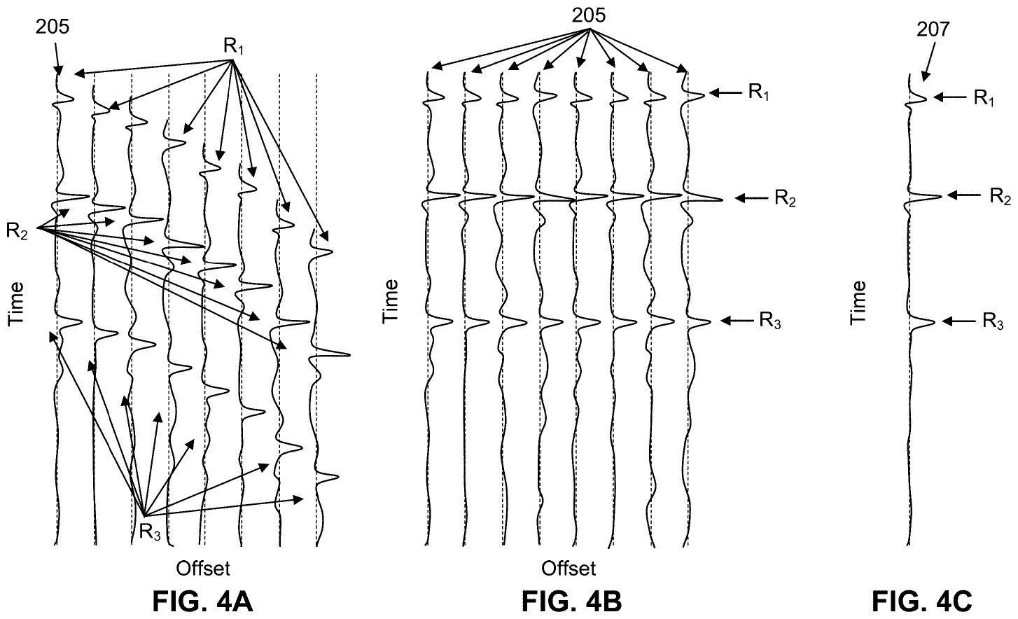

FIGS. 4A, 4B, and 4C schematically illustrate the process of stacking a group of seismic traces 205 to improve the signal to noise ratio of the traces. FIG. 4A illustrates a common midpoint (CMP) gather of eight of the seismic traces 205 generated by a set of sources and sensors that share a common midpoint. For ease of explanation, the traces are assumed to have been generated by reflections from three horizontal horizons.

The seismic traces 205 are arranged with increasing offset from the CMP. The offset of the seismic traces 205 from the CMP increases from left to right and the reflection time increases from top to bottom. Increasing offset from the common midpoint increases the angle of a seismic wave that between a source and a sensor, increases the distance the wave travels between the source and the sensor, and increases the slant reflection time. The increasing time for the reflections (R1, R2, R3) from each of the horizons to arrive for source-sensor pairs with increasing offsets from the CMP reflects this increased slant time.

FIG. 4B shows the seismic traces 205 after normal moveout (NMO) correction. NMO is the difference between vertical reflection time and the slant reflection time for a given source-sensor pair. This correction places reflections (R1, R2, R3) from common horizons at the same arrival time. The NMO correction is a function of the vertical reflection time for a specific horizon, the offset of a specific source-sensor pair, and the velocity of the seismic wave in the subterranean formation. The vertical reflection time for a specific horizon and the offset for a specific source-sensor pair are known parameters for each trace. However, the velocity is usually not readily available. As previously discussed, the velocity of seismic waves depends properties, for example, density, porosity, and fluid content, of the medium through which the seismic waves are traveling and consequently varies with location in the subterranean formation be studied.

FIG. 4C shows a stack trace 207 generated by summing the seismic traces 205 of the CMP gather and dividing the resulting amplitudes by the number of traces in the gather. The number of traces in the gather is also referred to as the fold of the gather. The noise tends to cancel out and the reflections (R1, R2, R3) from the horizons of the subterranean formation are enhanced.

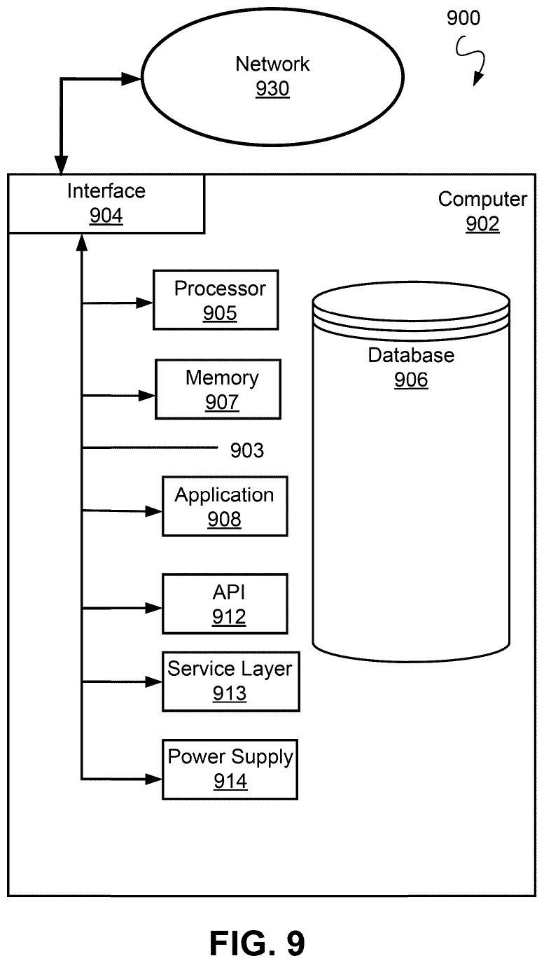

FIG. 5 illustrates a workflow 500 for identifying fault patterns in seismic data, according to some implementations. For convenience, the workflow 500 will be described as being performed by a computer system having one or more computers located in one or more locations and programmed appropriately in accordance with this specification. An example of the computer system is the computing system 900 illustrated in FIG. 9 described below.

As described in more detail below, the computer system uses seismic data to interpret the structure of a subsurface. In particular, the computer system generates structural seismic attributes, like dip and azimuth, on a surface. The computer system uses the structural attributes to identify fault patterns in the subsurface. The computer system then converts the fault patterns to fault polygons that identify the locations of the fault patterns in the subsurface.

At 502, workflow 500 involves the computer system interpreting input seismic data to identify a seismic horizon. A seismic horizon is a distinct layer or boundary within the subsurface that reflects seismic waves. The input seismic data can be three-dimensional seismic data, e.g., the three-dimensional volumes previously described. In some examples, interpreting the seismic data includes picking and tracking one or more laterally consistent seismic reflectors in the seismic data, perhaps at the level of interest for the purpose of mapping geologic features. Laterally consistent seismic reflectors are those reflections that are continuous and consistent across a horizontal plane. Tracking involves following these reflections across different seismic lines or data points to understand the extent and continuity of the geological feature. Here, a level of interest is a level that is affecting the preservation or production of hydrocarbons. For example, a hydrocarbon bearing rock could be the level of interest. Picking seismic reflectors involves analyzing seismic sections (which can be 2D or 3D) and marking the points where reflections from subsurface layers appear. This can be performed by identifying continuous waveforms or linear features on the seismic data that represent the reflection or seismic horizon. In some examples, the relevant seismic horizon is selected based on user input. FIG. 6A illustrates a temporal three-dimensional subsurface without fault polygons.

At 504, workflow 500 involves the computer system converting the seismic data describing the seismic horizon into a surface graphical representation of the seismic horizon. In some examples, this step involves filling gaps in the output of the seismic interpretation in order to generate a more complete representation of the surface. The computer system can use a gridding algorithm to fill in the gaps to generate a three-dimensional image of the subsurface, e.g., (x,y) spatial dimensions and a (z) depth or temporal dimension. In particular, the computer system uses the gridding algorithm to interpolate and resample the irregularly spaced seismic data onto a regular grid. In some examples, to perform gridding, the computer system defines over an area of interest a grid made up of grid cells, where each grid cell represents a spatial location in the area of interest. Then, the computer system interpolates the available seismic data points to estimate seismic values at each grid cell, perhaps using techniques such as, nearest-neighbor, bilinear, and/or kriging interpolation, thereby creating a continuous representation of the subsurface on a regular grid.

At 506, workflow 500 involves the computer system performing surface conditioning. In some examples, this step involves removing small faults or misidentified faults by applying smoothing on the input surface. Smoothing involves applying various filtering techniques, e.g., Gaussian filtering, Median Smoothing, Frequency-Wavenumber (F-K) Filtering, etc., to the seismic signals to remove the small faults and/or other noise. Applying smoothing helps avoid scenarios in which noise obscures subtle faults.

At 508, workflow 500 involves the computer system generating dip and azimuth attributes in the three-dimensional image of the subsurface. Dip is defined as the angle between the steepest direction of a plane and a horizontal plane, where values range from 0 to 90 degrees. Azimuth is the direction (relative to north) that the plane is dipping, where values range from 0 to 360 degrees. In some examples, the computer system can calculate the dip and azimuth attributes in the three-dimensional image based on the temporal data indicating the depth across the surface. FIG. 6B illustrates dip attributes of the three-dimensional subsurface. And FIG. 6C illustrates an azimuth attribute of the three-dimensional subsurface.

At 510, workflow 500 involves the computer system providing the dip and azimuth attributes as input into a trained neural network that is trained to separate faulted and non-faulted areas based on the dip and azimuth attributes. In some implementations, the computer system employs an unsupervised neural network to leverage the dip and azimuth attributes to identify patterns and relationships that distinguish faulted from fault-free (or “un-faulted”) areas.

At 512, workflow 500 involves the computer system identifying the fault zones selected by the neural network. At 514, workflow 500 involves the computer system generating fault polygons by creating boundaries around fault zones (i.e., faulted areas). The computer system creates a boundary around the values assigned to faulted areas that serves as fault polygon. Thus, the computer system generates a graphical representation of the faulted areas in the target surface.

At 516, workflow 500 involves the computer system performing a quality check on the generated fault polygons. In particular, the computer system assesses the fault polygons to determine whether they provide the desired level of detail. If the fault polygons do not provide the desired level of detail, the computer system returns to step 506 of surface conditioning. If the fault polygons do provide the desired level of detail, however, the computer system moves to step 518. In some examples, the desired level of detail is determined based on a user input and/or a scope of the project. For example, a regional project only requires information related to major faults (i.e., information on minor faults would not be required). If the output includes more than a threshold number of minor faults, then smoothing is applied on the surface to focus on major faults.

At 518, the computer system outputs the surface with fault polygons. In some examples, the computer system provides the surface with fault polygons for display on a display device of the computer system or another system. The displayed representation of the fault polygons depicts locations of faults that otherwise would not have been identified by existing systems.

FIG. 6D illustrates faulted and non-faulted areas in the three-dimensional subsurface. FIG. 6E illustrates fault polygons that identify faulted and non-faulted areas in the three-dimensional subsurface. FIG. 6F illustrates the temporal three-dimensional subsurface with imposed fault polygons.

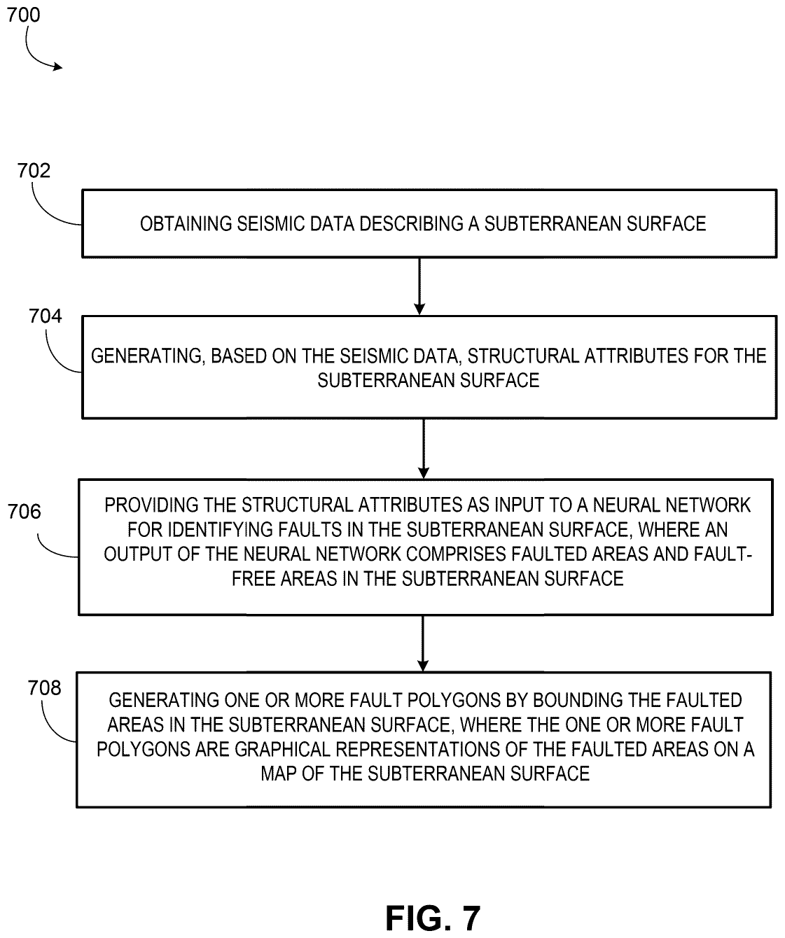

FIG. 7 illustrates a flowchart of an example method 700, according to some implementations. For clarity of presentation, the description that follows generally describes method 700 in the context of the other figures in this description. For example, method 700 can be performed by computer system 900 of FIG. 9. It will be understood that method 700 can be performed, for example, by any suitable system, environment, software, hardware, or a combination of systems, environments, software, and hardware, as appropriate. In some implementations, various steps of method 200 can be run in parallel, in combination, in loops, or in any order.

At 702, the method involves obtaining seismic data describing a subterranean surface.

At 704, the method generating, based on the seismic data, structural attributes for the subterranean surface.

At 706, the method providing the structural attributes as input to a neural network for identifying faults in the subterranean surface, where an output of the neural network includes faulted areas and fault-free areas in the subterranean surface.

At 708, the method generating one or more fault polygons by bounding the faulted areas in the subterranean surface, where the one or more fault polygons are graphical representations of the faulted areas on a map of the subterranean surface.

In some implementations, obtaining seismic data describing the subterranean surface involves receiving a three-dimensional (3D) seismic volume of a subterranean formation; and picking the subterranean surface from the 3D seismic volume of the subterranean formation.

In some implementations, the method further involves applying a surface conditioning algorithm to the seismic data describing the subterranean surface.

In some implementations, the neural network is an unsupervised neural network.

In some implementations, the method further involves performing a quality check on the one or more fault polygons.

In some implementations, the method further involves displaying, on a display device, the map of the subterranean surface and the one or more fault polygons imposed on the map of the subterranean surface.

In some implementations, the structural attributes include dip and azimuth attributes.

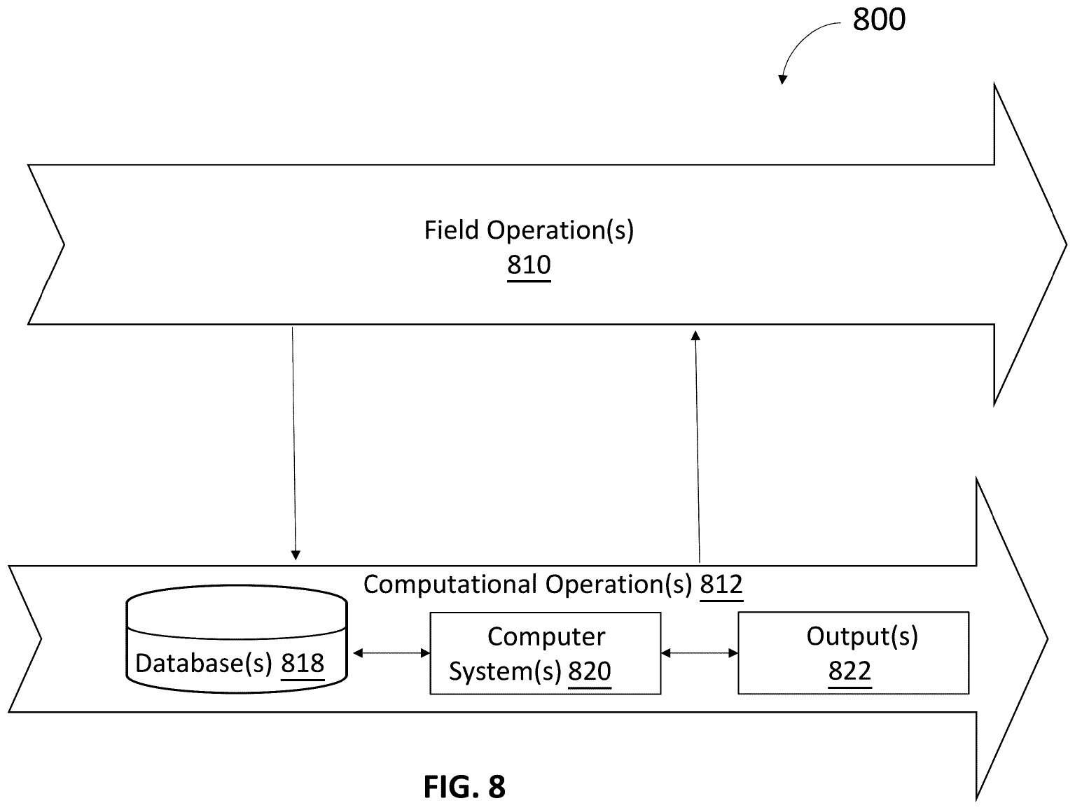

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 9 is a block diagram of an example computer system 900 that can be used to provide computational functionalities associated with described algorithms, methods, functions, processes, flows, and procedures, according to some implementations of the present disclosure.

The illustrated computer 902 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 902 can include a Smart Embedded Management Agent (SEMA), such as a built-in ADLINK SEMA 2.2, and a video sync technology, such as Quick Sync Video technology supported by ADLINK MSDK+. In some examples, the computer 902 can include the MXE-5400 Series processor-based fanless embedded computer by ADLINK, though the computer 902 can take other forms or include other components.

The computer 902 can serve in a role as a client, a network component, a server, a database, a persistency, or components of a computer system for performing the subject matter described in the present disclosure. The illustrated computer 902 is communicably coupled with a network 930. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 930 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 903. In some implementations, any or all of the components of the computer 902, including hardware or software components, can interface with each other or the interface 904 (or a combination of both), over the system bus. Interfaces can use an application programming interface (API) 912, a service layer 913, or a combination of the API 912 and service layer 913. The API 912 can include specifications for routines, data structures, and object classes. The API 912 can be either computer-language independent or dependent. The API 912 can refer to a complete interface, a single function, or a set of APIs 912.

The service layer 913 can provide software services to the computer 902 and other components (whether illustrated or not) that are communicably coupled to the computer 902. The functionality of the computer 902 can be accessible for all service consumers using this service layer 913. Software services, such as those provided by the service layer 913, can provide reusable, defined functionalities through a defined interface. For example, the interface can be software written in JAVA, C++, or a language providing data in extensible markup language (XML) format. While illustrated as an integrated component of the computer 902, in alternative implementations, the API 912 or the service layer 913 can be stand-alone components in relation to other components of the computer 902 and other components communicably coupled to the computer 902. Moreover, any or all parts of the API 912 or the service layer 913 can be implemented as child or sub-modules of another software module, enterprise application, or hardware module without departing from the scope of the present disclosure.

The computer 902 can include an interface 904. Although illustrated as a single interface 904 in FIG. 9, two or more interfaces 904 can be used according to particular needs, desires, or particular implementations of the computer 902 and the described functionality. The interface 904 can be used by the computer 902 for communicating with other systems that are connected to the network 930 (whether illustrated or not) in a distributed environment. Generally, the interface 904 can include, or be implemented using, logic encoded in software or hardware (or a combination of software and hardware) operable to communicate with the network 930. More specifically, the interface 904 can include software supporting one or more communication protocols associated with communications. As such, the network 930 or the interface's hardware can be operable to communicate physical signals within and outside of the illustrated computer 902.

The computer 902 includes a processor 905. Although illustrated as a single processor 905 in FIG. 9, two or more processors 905 can be used according to particular needs, desires, or particular implementations of the computer 902 and the described functionality. Generally, the processor 905 can execute instructions and manipulate data to perform the operations of the computer 902, including operations using algorithms, methods, functions, processes, flows, and procedures as described in the present disclosure.

The computer 902 can also include a database 906 that can hold data for the computer 902 and other components connected to the network 930 (whether illustrated or not). For example, database 906 can be an in-memory, conventional, or a database storing data consistent with the present disclosure. In some implementations, the database 906 can be a combination of two or more different database types (for example, hybrid in-memory and conventional databases) according to particular needs, desires, or particular implementations of the computer 902 and the described functionality. Although illustrated as a single database 906 in FIG. 9, two or more databases (of the same, different, or combination of types) can be used according to particular needs, desires, or particular implementations of the computer 902 and the described functionality. While database 906 is illustrated as an internal component of the computer 902, in alternative implementations, database 906 can be external to the computer 902.

The computer 902 also includes a memory 907 that can hold data for the computer 902 or a combination of components connected to the network 930 (whether illustrated or not). Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 (of the same, different, or combination of types) can be used according to particular needs, desires, or particular implementations of the computer 902 and the described functionality. While memory 907 is illustrated as an internal component of the computer 902, in alternative implementations, memory 907 can be external to the computer 902.

An application 908 can be an algorithmic software engine providing functionality according to particular needs, desires, or particular implementations of the computer 902 and the described functionality. For example, an application 908 can serve as one or more components, modules, or applications 908. Multiple applications 908 can be implemented on the computer 902. Each application 908 can be internal or external to the computer 902.

The computer 902 can also include a power supply 914. The power supply 914 can include a rechargeable or non-rechargeable battery that can be configured to be either user- or non-user-replaceable. In some implementations, the power supply 914 can include power-conversion and management circuits, including recharging, standby, and power management functionalities. In some implementations, the power-supply 914 can include a power plug to allow the computer 902 to be plugged into a wall socket or a power source to, for example, power the computer 902 or recharge a rechargeable battery.

There can be any number of computers 902 associated with, or external to, a computer system including computer 902, with each computer 902 communicating over network 930. Further, the terms “client,” “user,” and other appropriate terminology can be used interchangeably without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
obtaining seismic data describing a subterranean surface;
generating, based on the seismic data, structural attributes for the subterranean surface;
providing the structural attributes as input to a neural network for identifying faults in the subterranean surface, wherein an output of the neural network comprises faulted areas and fault-free areas in the subterranean surface; and
generating one or more fault polygons by bounding the faulted areas in the subterranean surface, wherein the one or more fault polygons are graphical representations of the faulted areas on a map of the subterranean surface.

2. The computer-implemented method of claim 1, wherein obtaining seismic data describing the subterranean surface comprises:
receiving a three-dimensional (3D) seismic volume of a subterranean formation; and
picking the subterranean surface from the 3D seismic volume of the subterranean formation.

3. The computer-implemented method of claim 2, further comprising applying a surface conditioning algorithm to the seismic data describing the subterranean surface.

4. The computer-implemented method of claim 1, wherein the neural network is an unsupervised neural network.

5. The computer-implemented method of claim 1, further comprising:
performing a quality check on the one or more fault polygons.

6. The computer-implemented method of claim 1, further comprising:
displaying, on a display device, the map of the subterranean surface and the one or more fault polygons imposed on the map of the subterranean surface.

7. The computer-implemented method of claim 1, wherein the structural attributes comprise dip and azimuth attributes.

8. One or more non-transitory computer-readable storage media coupled to one or more processors and having instructions stored thereon which, when executed by the one or more processors, cause the one or more processors to perform operations comprising:
obtaining seismic data describing a subterranean surface;
generating, based on the seismic data, structural attributes for the subterranean surface;
providing the structural attributes as input to a neural network for identifying faults in the subterranean surface, wherein an output of the neural network comprises faulted areas and fault-free areas in the subterranean surface; and
generating one or more fault polygons by bounding the faulted areas in the subterranean surface, wherein the one or more fault polygons are graphical representations of the faulted areas on a map of the subterranean surface.

9. The one or more non-transitory computer-readable storage media of claim 8, wherein obtaining seismic data describing the subterranean surface comprises:
receiving a three-dimensional (3D) seismic volume of a subterranean formation; and
picking the subterranean surface from the 3D seismic volume of the subterranean formation.

10. The one or more non-transitory computer-readable storage media of claim 9, the operations further comprising applying a surface conditioning algorithm to the seismic data describing the subterranean surface.

11. The one or more non-transitory computer-readable storage media of claim 8, wherein the neural network is an unsupervised neural network.

12. The one or more non-transitory computer-readable storage media of claim 8, the operations further comprising:
performing a quality check on the one or more fault polygons.

13. The one or more non-transitory computer-readable storage media of claim 8, the operations further comprising:
displaying, on a display device, the map of the subterranean surface and the one or more fault polygons imposed on the map of the subterranean surface.

14. The one or more non-transitory computer-readable storage media of claim 8, wherein the structural attributes comprise dip and azimuth attributes.

15. A system comprising:
one or more processors configured to perform operations comprising:
obtaining seismic data describing a subterranean surface;
generating, based on the seismic data, structural attributes for the subterranean surface;
providing the structural attributes as input to a neural network for identifying faults in the subterranean surface, wherein an output of the neural network comprises faulted areas and fault-free areas in the subterranean surface; and
generating one or more fault polygons by bounding the faulted areas in the subterranean surface, wherein the one or more fault polygons are graphical representations of the faulted areas on a map of the subterranean surface.

16. The system of claim 15, wherein obtaining seismic data describing the subterranean surface comprises:
receiving a three-dimensional (3D) seismic volume of a subterranean formation; and
picking the subterranean surface from the 3D seismic volume of the subterranean formation.

17. The system of claim 16, the operations further comprising applying a surface conditioning algorithm to the seismic data describing the subterranean surface.

18. The system of claim 15, wherein the neural network is an unsupervised neural network.

19. The system of claim 15, the operations further comprising:
performing a quality check on the one or more fault polygons.

20. The system of claim 15, the operations further comprising:
displaying, on a display device, the map of the subterranean surface and the one or more fault polygons imposed on the map of the subterranean surface.
